(19) United States
(12) Patent Application Publication
(10) Pub. No.: US 2012/0029725 A1
(43) Pub. Date: Feb. 2, 2012

(54) SMART HYBRID THERMOSTAT

(75) Inventors: Robert Lafleur, Louisville, KY (US); Nagaraju Valluri, Louisville, KY (US); John K. Besore, Prospect, KY (US); Timothy Dale Worthington, Crestwood, KY (US); Michael Francis Finch, Louisville, KY (US); Jeffrey Donald Drake, Louisville, KY (US)

(73) Assignee: General Electric Company

(21) Appl. No.: 12/970,121

(22) Filed: Dec. 16, 2010

(51) Int. Cl. G05D 23/19

(52) U.S. Cl. 700/300

(57) ABSTRACT

A system and method for controlling operation of a hybrid heating system that includes a heat pump and a gas heater is disclosed. Peak demand or pricing information is received from gas and electric utilities, and outdoor ambient temperature data is also fed to a smart hybrid thermostat. A controller processes this data and calculates overall efficiency of operating the heat pump versus the gas heater by accessing stored performance data relating to the heat pump in memory.

### BACKGROUND OF THE DISCLOSURE

The present disclosure generally relates to energy management, and more particularly to energy management or demand supply management (DSM) of household consumer devices. The disclosure finds particular application to modifying or incorporating energy savings features and functions, and specifically with respect to a hybrid central heating system.

Generally, utilities charge a flat rate but as fuel prices increase and there is associated high energy use during select parts of the day, utilities have become more sophisticated with variable rates relating to the energy supplied to customers and more particularly to variable rates at different times of the day. As a result, customers or homeowners are charged a higher rate during peak demand periods when energy use is high, and a lower rate when demand for energy is reduced. Therefore, operating a home appliance or system during different rate periods can result in a substantial difference in energy costs to the homeowner.

Potential cost savings associated with selective control of a central heating system is another area where improvement can be made. Thermostats are used to control operation of central heating systems and regulate the temperature of one or more rooms by setting a temperature set point and monitoring the temperature within the home. If the temperature within the room falls outside the upper or lower set point, the thermostat sends an appropriate signal to operate a cooling or heating schedule as deemed necessary. In a hybrid central heating system (hybrid meaning use of both gas heat and a heat pump in the central heating system), operation of the system depends in part on user input programming of the thermostat to determine a cutoff point and outdoor temperature of when the system will operate in a heat pump or gas heat mode. If there are no demand response events (no peak demand or peak pricing period), the heat pump cycle can operate as scheduled. However, at certain outdoor and indoor combination temperatures, it is more efficient and economical to supply heating from the gas heater rather than heating the home with the heat pump of the hybrid central heating system. Therefore, for example, operating the heat pump during a peak demand or peak price period will result in a corresponding increase in the cost of usage. Likewise, at certain low outdoor temperatures or very warm indoor setpoint temperatures, it is more economical to heat the home with the gas heater. One skilled in the art of refrigerant systems will understand that the efficiency, capacity and power consumption of such a system is a function of both the indoor temperature (condenser operating temperature/pressure) and the outdoor temperature (evaporator operating temperature/pressure).

Still another variable is that homeowners often describe the heat supplied to the home from a heat pump as a “cool” heat and desire to instead operate gas heat portion of the hybrid central heating system. Therefore, a need exists to increase the efficiency of a hybrid central heating system, provide additional savings to the home owner, and satisfies the desires of the homeowner under certain conditions.

### SUMMARY OF THE DISCLOSURE

A smart logic thermostat for a hybrid central heating system is configured to automatically determine the most efficient and economical mode for heating the homeowner's home.

The thermostat for controlling operation of hybrid central system that includes a heat pump and a gas heater in response to a demand response signal indicative of at least a peak demand period and an off-peak demand period includes a data receiver for receiving data relating to outdoor ambient temperature, indoor temperature data, and utility pricing from an external information source. A memory stores performance data for the heat pump. A controller operatively communicates with the memory and the data receiver, using the outdoor temperature data and the indoor temperature data and the utility pricing information in combination with the performance data stored in the memory to calculate the cost effectiveness of the heat pump versus the gas furnace, and determine whether to heat with the heat pump or the gas furnace.

In one preferred arrangement, the data receiver is configured to receive the information wirelessly.

In another arrangement, the data receiver receives outdoor temperature data through the Internet.

The data receiver is configured to receive pricing data from an associated utility, and the pricing information includes both electricity prices and gas prices.

A user interface is configured to allow a homeowner to switch to gas heat on demand and includes the ability to override a controller determination to use the heat pump.

The method of operating a temperature control system that includes a heat pump and a gas heater includes receiving data related to outdoor ambient temperature, indoor temperature, receiving utility pricing information from an external information source, storing performance data for the heat pump in the memory, calculating efficient temperature control using the temperature data, utility pricing, and performance data, and operating a gas heater and heat pump based on the calculating step.

The method further includes programming set points into the system.

The programming includes creating a heating/cooling schedule to run the heat pump based on weather information, indoor setpoint, and utility pricing, and dynamically updating the schedule based on weather changes.

The method further includes the ability to override the calculating step and allow the homeowner to select use of the gas heater irrespective of the calculating step.

A primary benefit is the ability to increase the efficiency of a central heating system, and primarily a hybrid central heating system.

Another advantage relates to improved savings for the homeowner.

Still another benefit resides in the ability to operate the thermostat in a programmable or non-programmable manner.

Yet another advantage relates to providing the homeowner with the option of using an emergency heat mode to switch to gas heat and bypass the smart logic calculation if so desired.

Still other benefits and advantages of the present disclosure will become more apparent upon reading and understanding the following detailed description.

### BRIEF DESCRIPTION OF THE DRAWINGS

FIG. 1 is a schematic illustration of an exemplary demand managed hybrid central heating system.

FIG. 2 shows a flowchart for the smart hybrid thermostat of the present disclosure.

### DETAILED DESCRIPTION OF THE PREFERRED EMBODIMENTS

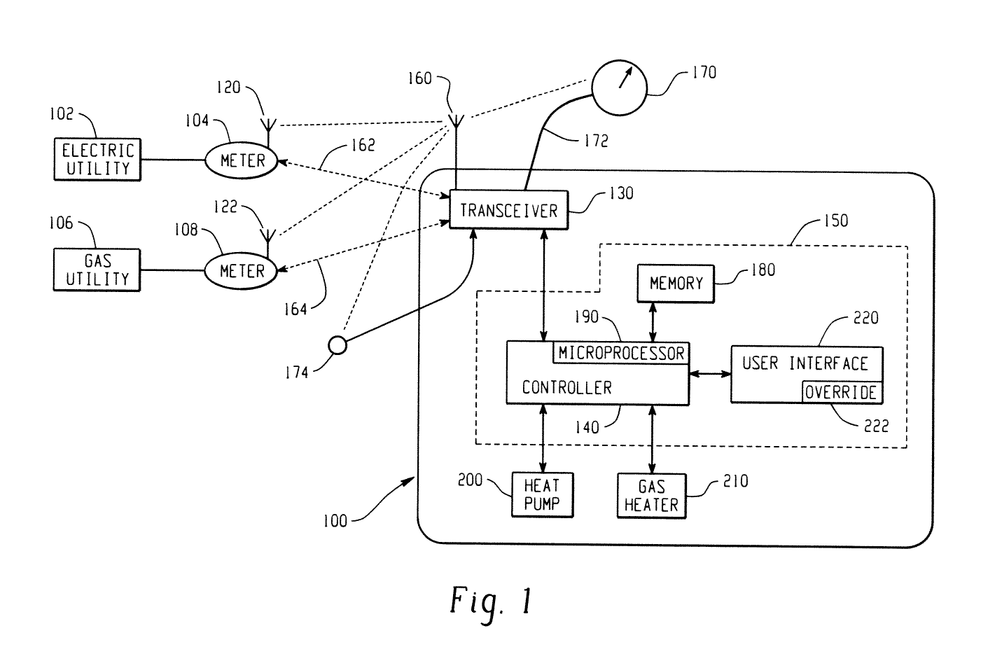

FIG. 1 shows a schematic representation of the heating system and particularly a hybrid central heating system 100. The system 100 communicates with a first utility 102 that provides electrical power to the home. The amount of electricity used is typically monitored through meter 104 and likewise pricing data or a demand signal (e.g., a signal representative of the demand being at a “critical”, “high”, “medium” or “low” level) is provided by the electric utility to the meter 104. Similarly, gas utility 106 supplies natural gas to the home and the amount of gas is monitored through meter 108. Further, pricing data or a demand signal is provided to the meter 108 by the gas utility. Pricing information can also be provided to the system via other wireless or wired means such as Wifi PLC, Broadband, or other RF protocols.

The pricing data or demand signal that is provided by each of the utilities may be a wireless communication as evidenced by antennas 120, 122 associated with each meter. This schematic representation does not require that a physical antenna be provided at each meter, but rather is indicative that data representative of, for example, a peak demand or peak pricing period is provided by each utility. As will be understood by one skilled in the art, the information may be alternatively received in a wired manner. A receiver or transceiver 130 operatively communicates with a controller 140 that is part of smart thermostat 150. The transceiver 130 preferably includes an antenna 160 to receive a wireless signal, or the transceiver may receive data in a wired manner as represented by paths 162, 164 extending between the respective meters 104, 108, and the transceiver 130. In addition, the transceiver 130 receives data relating to outdoor ambient temperature as schematically represented by sensor 170 and indoor temperature as schematically represented by sensor 174. The sensor or thermometer 170 may be located outside the home and, again, is able to communicate either wirelessly with transceiver antenna 160 or through a wired connection 172 with the transceiver. Thermometer 170 may also be associated with a homeowner's WiFi network which provides the current outdoor ambient temperature to be transmitted via the internet or some website. Likewise, sensor or thermometer 174 is typically located in the thermostat 150 but can also be located remotely from the thermostat to provide the current indoor temperature to the transceiver 130 in either a wired or wireless manner.

As will be appreciated, the transceiver 130 receives the information regarding utility pricing for electric and gas, as well as the outdoor ambient temperature and the indoor temperature. In turn, the transceiver communicates with controller 140 which also is operatively associated with data memory 180. The memory 180 includes a lookup table that stores data regarding the coefficient of performance characteristics, capacity, and power consumption data for the given refrigerant system in relation to evaporator and condenser temperatures of the heat pump 200 used in the hybrid central heating system 100. One skilled in the art of thermodynamics will understand that the evaporator and condenser temperatures can be estimated from the indoor and outdoor temperatures based on general relationships of delta T known in the industry. These temperatures could also be read directly using wireless or wired transducers reporting back to the system. Likewise, the system can also be programmed to store run time data for the heat pump and the gas furnace with respect to the indoor and outdoor temperature combinations. This can be a tabular lookup table or can be in the form of a regression curve fit analysis. The controller 140 and microprocessor portion 190 of the controller includes embedded software that processes information regarding the outdoor temperature, indoor temperature, and gas and electric utility pricing, and calculates via data stored in the memory whether or not it is more economical to run the heat pump 200 or the gas heater 210 to heat the home. This decision can automatically be made based on the results of an “onboard” calculation by the system by utilizing the heat pump efficiency, capacity, and power consumption from the lookup table or regression along with the utility resource costs and the capacity and operating costs for the gas furnace. Additionally, a user interface 220 is preferably associated with the thermostat 150 and communicates with the controller 140. In this manner, the homeowner can input data as well as effectively review information received from the controller and displayed on the interface 220.

In one preferred arrangement, the smart thermostat 150 uses a wireless communication that is configured to communicate with the consumer's wireless network and receive information regarding the current outdoor ambient temperature, indoor temperature, and electric and gas utility prices or demand signals. When the system calls for a heating mode, the thermostat determines the outdoor ambient temperature from a website, for example, and information is collected regarding the indoor temperature, local utility electric and gas prices or present demand signals. The thermostat runs an algorithm using the lookup table to determine whether the gas heater 210 or heat pump 200 is more economical to heat the home. If the hybrid system 100 is operating the heat pump, and the homeowner/consumer determines that the air temperature coming through the ducts is not “warm enough”, the consumer can opt to use an override or an emergency heat mode 222 like a standard thermostat to switch to the gas heater 210. In other words, if the algorithm suggests to the homeowner that the heat pump 200 should be used, or in fact via prior programming is operating the heating cycle with the heat pump, the homeowner has the ability to bypass the smart logic if so desired by activating the override 222.

It will be recognized that the smart thermostat 150 described above could be available as either a programmable or non-programmable model and still take advantage of the benefit of assessing the efficiency of the central heating system to provide potential savings to the homeowner during a peak demand period when utility pricing is increased. Likewise, either the programmable or non-programmable form of the thermostat used in the hybrid central heating system may incorporate the override feature.

There are various ways of operating a heat pump control and reducing a peak load on command. For example, the heat pump cycle can be scheduled to run if there are no demand response events in play, i.e., no peak pricing events are received. The heat pump can likewise be turned “on” or “off” to reduce the net usage. Control for driving the heat pump can be “on” or “off” at a preset percent duty cycle in an effort to reduce the net usage. In addition, knowing the outside temperature, the indoor temperature, and the weather information allows a predictive heater control algorithm to be generated to drive the heat pump and optimize the energy usage. In still another arrangement, heat/cool down schedules can be created to run the heat pump based on weather information and various demand response events. These schedules of the heat/cool down cycles can be dynamically updated based on changes in weather patterns or outdoor temperature.

Heat pumps run with some cycle time or run time, typically 60-70% @ 90 F in cooling mode and similar percentages at 32 F or whatever the rated temperature for the heating mode might be. If the heat pump is very undersized or the ambient outdoor temperature is very low and/or the indoor setpoint is set very high, the heat pump can run for extended periods of time that during a high or peak rate period will likely increase the cost of usage for the homeowner. However, by changing the schedule of operation based on demand response events, an associated decrease in cost usage will be experienced. It will also encourage homeowners and utilities to recommend using devices having the more energy efficient factor in order to reduce demand, save energy, and reduce cost.

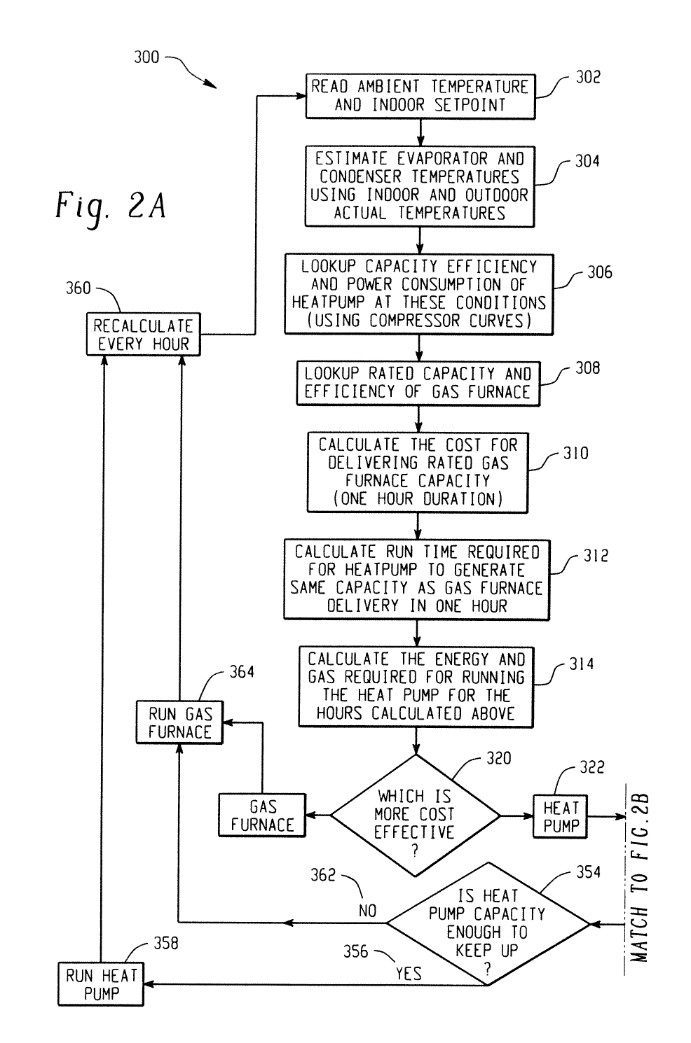

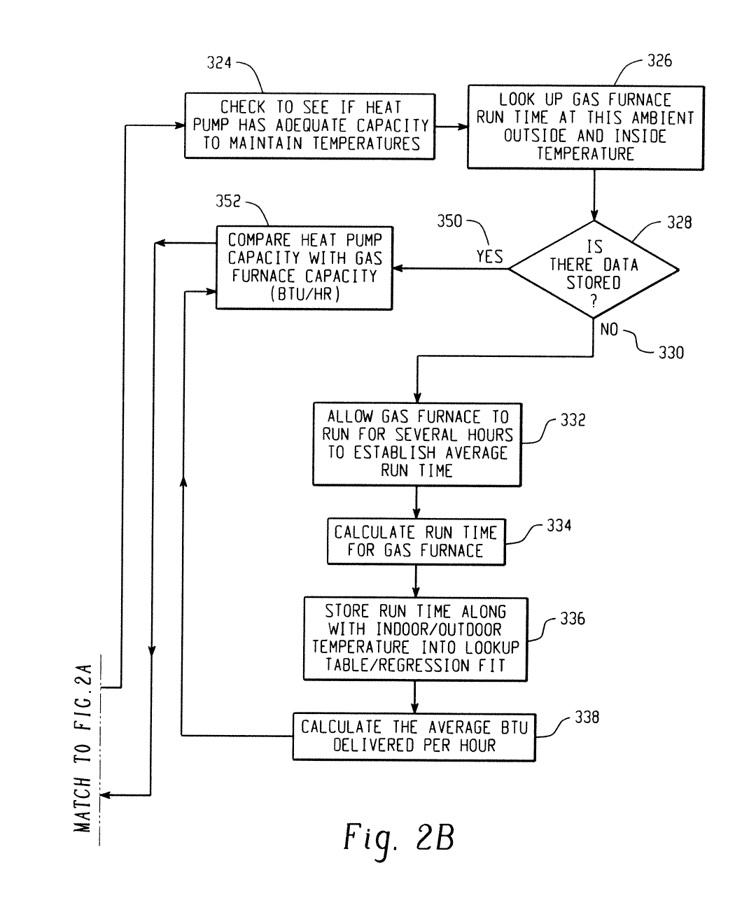

Shown in FIG. 2 is a representative flowchart or algorithm 300 used by the smart hybrid thermostat 150 in the hybrid central heating system 100. That is, when the indoor temperature in the home is such that a heating mode is called for, the hybrid thermostat 150 reads the ambient temperature and the indoor temperature in step 302. The controller 140 estimates the evaporator and condenser temperatures using the indoor and outdoor temperatures (step 304) in order to look up the capacity efficiency and power consumption of the heat pump at these conditions (using compressor curves stored in the thermostat memory 180) (step 306). The controller also looks up the rated capacity and efficiency of the gas furnace (step 308) in order to calculate the cost for delivering the rated gas furnace capacity (step 310). Likewise, the controller will calculate the run time (step 312) required for the heat pump to generate the same capacity as the gas furnace will deliver in a predetermined time period (e.g., one hour) so that the energy and cost required to operate the heat pump can be calculated (step 314) for the calculated run time from step 312. A comparison is then made by the controller in order to determine which is more cost effective (decision step 320).

If the heat pump is deemed to be more cost effective (step 322), then the thermostat determines if the heat pump has adequate capacity to maintain the setpoint temperature (step 324) and looks up the gas furnace runtime at this ambient outside temperature and the inside temperature (step 326). As part of the lookup step 326, the controller 140 looks to see if data is stored in the memory 180 (step 328). If no such data is available or stored (decision step 330), then the controller operates the gas furnace for several hours to establish an average run time (step 332), calculates the run time for the gas furnace (step 334), stores the run time along with the indoor and outdoor temperature information into the lookup table (step 336), and calculates the average BTU delivered per hour (step 338). In this manner, there is data to evaluate for comparison purposes. Thus, if there is data stored in the memory (step 350) either previously or as a result of steps 332-338, then a comparison is made of the heat pump capacity with the gas furnace capacity (e.g., compare BTU/hr) in step 352 in order to determine whether the heat pump capacity is enough to keep up (step 354). If the answer/decision is “yes” (step 356), then the heat pump is run (step 358) and the process is periodically re-calculated (e.g., every hour) (step 360). If the answer/decision is “no” (step 362), then the gas furnace is operated (step 364), and the process is re-calculated (step 360). Likewise, if the decision to step 320 is that the gas furnace is more effective to operate (step 366), then the gas furnace is operated (step 364) and the process is periodically re-calculated (step 360).

The flow chart of FIG. 2 is one exemplary process for evaluating whether the gas furnace or the heat pump is more cost effective. For purposes of the calculation, one skilled in the art can presume that the gas furnace will perform at 120,000 BTUs per hour at 80% efficiency, for example, that results in using 96,000 BTU/hr. If the gas furnace is operated for one hour (e.g. step 360), then the gas used is 96,000 BTUS. The gas rate can then be included in the calculation (e.g., 1040 BTU/ft³) in order to determine that about 92 ft³ of gas is used. If the cost of the gas from the utility is $0.006/ft³, then the total cost is $0.52. Again, by way of example, if the heat pump capacity is 50,000 BTU/hr, then the run time is calculated to be 1.92 hours (96,000 BTU/50,000 BTU/hr). This energy cost is then likewise calculated, e.g. 2000 watts×1.92 hrs equals 3840 Watt-hrs. At an approximate cost of $0.10/kWHr, the calculated cost to operate the heat pump is $0.38, and the resultant comparison under these exemplary conditions indicate that the heat pump is more cost effective ($0.52 versus $0.38). Of course, this is an example only in order to illustrate the process, and one skilled will understand that different values will lead to different results and conclusions without departing from the scope and intent of the present disclosure.

As noted above, through the user interface 220 (FIG. 1), the homeowner can select set points for different rate periods. The memory 180 stores the data and the microprocessor 190 controls the heater, air conditioner, etc. based on the demand supply signal and the set points that are established by the homeowner. The data receiver receives the outdoor temperature data from the sensor 170 or through the internet, such as by accessing a website, and the pricing data/demand signal from the associated utilities provide the desired information to the controller 140. Moreover, the user interface 220 is provided with an override option 222 to allow the homeowner to ignore the controller determination to use the heat pump if so desired.

The disclosure has been described with reference to the preferred embodiments. Obviously, modifications and alterations will occur to others upon reading and understanding the preceding detailed description. It is intended that the disclosure be construed as including all such modifications and alterations.

1. A system for controlling operation of a heat pump and a gas heater for heating and cooling an interior space, responsive to a demand response signal indicative of at least a peak demand period and an off-peak demand period, the system comprising:
a data receiver for receiving data relating to outdoor ambient temperature and utility pricing from an external information source;
a memory that stores performance data for the heat pump; and
a controller operatively associated with the memory and the data receiver that uses the outdoor temperature data and utility pricing in combination with heat pump performance data to determine whether to heat with the heat pump or the gas heater.

2. The system of claim 1 further comprising a temperature sensor for sensing the temperature of the interior space and wherein said controller further uses interior space temperature data to determine whether to heat with the heat pump or the gas heater.

3. The system of claim 1 wherein the data receiver is configured to receive Information wirelessly.

4. The system of claim 3 wherein the data receiver receives outdoor temperature data through the internet.

5. The system of claim 1 wherein the data receiver is configured to receive information through the internet.

6. The system of claim 5 wherein the data receiver accesses a website to determine outdoor ambient temperature.

7. The system of claim 1 wherein the data receiver is configured to receive pricing data from an associated utility.

8. The system of claim 7 wherein the pricing information relates to electricity prices.

9. The system of claim 8 wherein the pricing information relates to gas prices.

10. The system of claim 7 wherein the pricing information relates to gas prices.

11. The system of claim 1 further comprising a user interface configured to allow a homeowner to switch to gas heat on demand.

12. The system of claim 11 wherein the user interface overrides the controller determination to use the heat pump.

13. The system of claim 11 wherein the user interface includes an option to program set points into the system.

14. A method of operating a temperature control system that includes a heat pump and a gas heater comprising:
receiving data relating to outdoor ambient temperature;
receiving data relating to indoor temperature
receiving utility pricing from an external information source;
storing performance data for the heat pump in a memory;
calculating efficient temperature control using the outdoor ambient temperature data, indoor temperature data, utility pricing, and performance data; and
operating the gas heater and heat pump based on the calculating step.

15. The method of claim 14 further comprising overriding the calculating step.

16. The method of claim 15 wherein the overriding step includes using the gas heater.

17. The method of claim 14 further comprising programming set points into the system.

18. The method of claim 14 wherein the ambient outdoor temperature receiving step includes accessing a website through the internet.

19. The method of claim 14 wherein the ambient outdoor temperature receiving step includes receiving the temperature wirelessly.

20. The method of claim 14 further comprising creating a heat/cool down schedule to run the heat pump based on weather information and utility pricing, and dynamically updating the schedule based weather changes.
